(19) United States
(12) Patent Application Publication
(10) Pub. No.: US 2017/0279771 A1
(43) Pub. Date: Sep. 28, 2017

(54) PACKET PROCESSING METHOD, NETWORK SERVER, AND VIRTUAL PRIVATE NETWORK SYSTEM

(71) Applicant: HUAWEI TECHNOLOGIES CO., LTD., Shenzhen (CN)

(72) Inventor: Jun LI, Beijing (CN)

(73) Assignee: HUAWEI TECHNOLOGIES CO., LTD., Shenzhen (CN)

(21) Appl. No.: 15/612,285

(22) Filed: Jun. 2, 2017

Related U.S. Application Data
(63) Continuation of application No. PCT/CN2015/096303, filed on Dec. 3, 2015.

(30) Foreign Application Priority Data
Dec. 5, 2014 (CN) 201410735369.7

(51) Int. Cl. H04L 29/06

(52) U.S. Cl. CPC H04L 63/0272; H04L 63/0236

(57) ABSTRACT

Embodiments of the present application relate to the communications field, and disclose a packet processing method, a network server, and a virtual private network system. The method includes: receiving, by a network server, a first packet sent by an access device, where the first packet includes an identifier of a first user, and the identifier of the first user is used to identify the first user; searching, by the network server, an already stored first list for a suppressed state identifier of the first user according to the identifier of the first user; and discarding, by the network server, the first packet when the first list includes the suppressed state identifier of the first user, where the suppressed state identifier of the first user is used to indicate not to provide services to the first user.

### CROSS-REFERENCE TO RELATED APPLICATIONS

This application is a continuation of International Application No. PCT/CN2015/096303, filed on Dec. 03, 2015, which claims priority to Chinese Patent Application No. 201410735369.7, filed on Dec. 5, 2014. The disclosures of the aforementioned applications are hereby incorporated by reference in their entireties.

### TECHNICAL FIELD

The present application relates to the communications field, and in particular, to a packet processing method, a network server, and a virtual private network system.

### BACKGROUND

A VPDN (virtual private dial up network) refers to a virtual private network implemented by accessing a private network by using a dialing function of a public network, so that remote users of an enterprise can access an intranet of the enterprise by using the public network.

In the prior art, a user device establishes a session with an LNS (Layer 2 Tunneling Protocol Network Server) by using an LAC (Layer 2 Tunneling Protocol Access Concentrator), so as to access a virtual private network. If a user gets online repeatedly or fails in online authentication consecutively for many times, the LAC confirms that the user is an unauthorized user and sets the user in a suppressed state. The LAC directly rejects an access request of the user, and restores services for the server after the suppression lasts a period of time. However, the LAC is an access device of a local ISP (Internet Service Provider). LAC devices of different service providers have different suppression mechanisms for users, while a quantity of sessions or tunnels that can be established on an LNS is fixed, and if there are excessively many unauthorized users establishing sessions on the LNS, authorized users cannot get online. Therefore, a virtual private network system cannot suppress unauthorized users effectively.

### SUMMARY

Embodiments of the present application provide a packet processing method, a network server, and a virtual private network system, so as to resolve a problem that a virtual private network system cannot effectively suppress unauthorized users.

To achieve the foregoing objective, the following technical solutions are used in the embodiments of the present application:

According to a first aspect, a virtual private network system includes a network server, an access device, and a user device, where

the user device is configured to send a first packet to the access device, where the first packet includes an identifier of a first user, and the identifier of the first user is used to identify the first user;

the access device is configured to: receive the first packet sent by the user device, search an already stored second list for a suppressed state identifier of the first user according to the identifier of the first user, and send the first packet to the network server when the second list does not include the suppressed state identifier of the first user, where the suppressed state identifier of the first user is used to indicate not to provide services to the first user; and

the network server is configured to: receive the first packet sent by the access device, search an already stored first list for the suppressed state identifier of the first user according to the identifier of the first user, and discard the first packet when the first list includes the suppressed state identifier of the first user.

With reference to the first aspect, in a first possible implementation manner,

the network server is further configured to: record an occurrence time of a first fault of the first user, and accumulate a quantity of times of faults, where the quantity of times of faults is at least one of a quantity of times that the first user fails to get online on the network server or a quantity of times that the first user gets offline on the network server, or the quantity of times of faults is a sum of a quantity of times that the first user fails to get online on the network server and a quantity of times that the first user gets offline on the network server; store the suppressed state identifier of the first user in the first list when the quantity of times of faults of the first user within first duration is greater than or equal to a first threshold; and clear the quantity of times of faults of the first user after a time length, since the occurrence time of the first fault, of accumulating the quantity of times of faults by the network server reaches the first duration.

With reference to the first aspect or the first possible implementation manner of the first aspect, in a second possible implementation manner,

the network server is further configured to delete the suppressed state identifier of the first user from the first list after a time length for which the network server stores the suppressed state identifier of the first user in the first list reaches second duration.

With reference to the first aspect, in a third possible implementation manner,

the network server is further configured to send a second packet to the access device when the first list includes the suppressed state identifier of the first user, where the second packet includes the suppressed state identifier of the first user; and

the access device is further configured to: receive the second packet sent by the network server, record the suppressed state identifier of the first user in the second list, and stop providing services to the first user.

With reference to any one of the first aspect to the third possible implementation manner of the first aspect, in a fourth possible implementation manner,

the access device is further configured to discard the first packet when the second list includes the suppressed state identifier of the first user.

According to a second aspect, a network server applied to a virtual private network system includes:

a receiving unit, configured to receive a first packet sent by an access device, where the first packet includes an identifier of a first user, and the identifier of the first user is used to identify the first user;

a searching unit, configured to search an already stored first list for a suppressed state identifier of the first user according to the identifier of the first user received by the receiving unit; and

a suppression unit, configured to discard the first packet when the first list searched by the searching unit includes the suppressed state identifier of the first user, where the suppressed state identifier of the first user is used to indicate not to provide services to the first user.

With reference to the second aspect, in a first possible implementation manner,

the suppression unit is further configured to: record an occurrence time of a first fault of the first user, and accumulate a quantity of times of faults, where the quantity of times of faults is at least one of a quantity of times that the first user fails to get online on the network server or a quantity of times that the first user gets offline on the network server, or the quantity of times of faults is a sum of a quantity of times that the first user fails to get online on the network server and a quantity of times that the first user gets offline on the network server; store the suppressed state identifier of the first user in the first list when the quantity of times of faults of the first user within first duration is greater than or equal to a first threshold; and clear the quantity of times of faults of the first user after a time length, since the occurrence time of the first fault, of accumulating the quantity of times of faults by the network server reaches the first duration.

With reference to the second aspect or the first possible implementation manner of the second aspect, in a second possible implementation manner,

the suppression unit is further configured to delete the suppressed state identifier of the first user from the first list after a time length for which the network server stores the suppressed state identifier of the first user in the first list reaches second duration.

With reference to any one of the second aspect to the second possible implementation manner of the second aspect, in a third possible implementation manner,

the network server further includes a sending unit, configured to send a second packet to the access device when the first list includes the suppressed state identifier of the first user, where the second packet includes the suppressed state identifier of the first user, so that the access device stops providing services to the first user according to the suppressed state identifier of the first user.

According to a third aspect, a packet processing method applied to a virtual private network system includes:

receiving, by a network server, a first packet sent by an access device, where the first packet includes an identifier of a first user, and the identifier of the first user is used to identify the first user;

searching, by the network server, an already stored first list for a suppressed state identifier of the first user according to the identifier of the first user; and

discarding, by the network server, the first packet when the first list includes the suppressed state identifier of the first user, where the suppressed state identifier of the first user is used to indicate not to provide services to the first user.

With reference to the third aspect, in a first possible implementation manner, the method further includes:

recording, by the network server, an occurrence time of a first fault of the first user, and accumulating a quantity of times of faults, where the quantity of times of faults is at least one of a quantity of times that the first user fails to get online on the network server or a quantity of times that the first user gets offline on the network server, or the quantity of times of faults is a sum of a quantity of times that the first user fails to get online on the network server and a quantity of times that the first user gets offline on the network server;

storing, by the network server, the suppressed state identifier of the first user in the first list when the quantity of times of faults of the first user within first duration is greater than or equal to a first threshold; and

clearing the quantity of times of faults of the first user after a time length, since the occurrence time of the first fault, of accumulating the quantity of times of faults by the network server reaches the first duration.

With reference to the third aspect or the first possible implementation manner of the third aspect, in a second possible implementation manner, the method further includes:

deleting, by the network server, the suppressed state identifier of the first user from the first list after a time length for which the network server stores the suppressed state identifier of the first user in the first list reaches second duration.

With reference to any one of the third aspect to the second possible implementation manner of the third aspect, in a third possible implementation manner, the method further includes:

sending, by the network server, a second packet to the access device when the first list includes the suppressed state identifier of the first user, where the second packet includes the suppressed state identifier of the first user, so that the access device stops providing services to the first user according to the suppressed state identifier of the first user.

According to a packet processing method, a network server, and a virtual private network system in the embodiments of the present application, a network server receives a first packet sent by an access device, searches an already stored first list for a state identifier of a first user according to an identifier of the first user, and discards the first packet if the state identifier is found. The network server participates in determining whether to suppress a user, so as to suppress unauthorized users efficiently and quickly, thereby resolving a problem in the prior art that a virtual private network system cannot effectively suppress unauthorized users.

### BRIEF DESCRIPTION OF DRAWINGS

To describe the technical solutions in the embodiments of the present application more clearly, the following briefly describes the accompanying drawings required for describing the embodiments. Apparently, the accompanying drawings in the following description show merely some embodiments of the present application, and a person of ordinary skill in the art may still derive other drawings from these accompanying drawings without creative efforts.

FIG. 1 is a schematic structural diagram of a virtual private network system according to an embodiment of the present application;

FIG. 2 is a schematic structural diagram of a network server according to an embodiment of the present application;

FIG. 3 is a schematic structural diagram of a network server according to another embodiment of the present application;

FIG. 4 is a schematic flowchart of a packet processing method according to an embodiment of the present application; and

FIG. 5 is a schematic diagram of information interaction of a packet processing method according to another embodiment of the present application.

### DESCRIPTION OF EMBODIMENTS

The following clearly describes the technical solutions in the embodiments of the present application with reference to the accompanying drawings in the embodiments of the present application. Apparently, the described embodiments are merely some but not all of the embodiments of the present application. All other embodiments obtained by a person of ordinary skill in the art based on the embodiments of the present application without creative efforts shall fall within the protection scope of the present application.

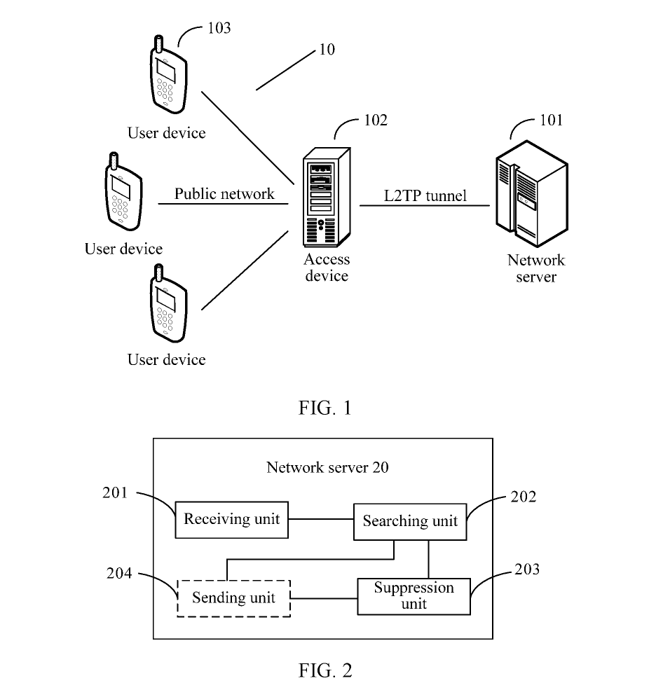

An embodiment of the present application provides a virtual private network system. Referring to FIG. 1, the virtual private network system 10 includes a network server 101, an access device 102, and a user device 103. Optionally, the network server 101 may be a layer 2 tunneling protocol network server LNS, and the access device 102 may be a layer 2 tunneling protocol access concentrator LAC. Certainly, this is only an example for description, and does not represent that the present application is limited thereto.

Optionally, in the virtual private network system shown in FIG. 1, the user device 103 establishes a connection to an LAC by using a public network, and the public network may be a PSTN (Public Switched Telephone Network), an ISDN (Integrated Services Digital Network), or the like. After the user device 103 establishes the connection to the LAC, the user device 103 may communicate with an LNS by using an L2TP tunnel established between the LAC and the LNS according to an L2TP (Layer 2 Tunneling Protocol).

In this embodiment of the present application, the user device 103 is configured to send a first packet to the access device 102, where the first packet includes an identifier of a first user, and the identifier of the first user is used to identify the first user.

The access device 102 is configured to: receive the first packet sent by the user device 103, search an already stored second list for a suppressed state identifier of the first user according to the identifier of the first user, and send the first packet to the network server 101 when the second list does not include the suppressed state identifier of the first user, where the suppressed state identifier of the first user is used to indicate not to provide services to the first user.

The network server 101 is configured to: receive the first packet sent by the access device 102, search an already stored first list for the suppressed state identifier of the first user according to the identifier of the first user, and discard the first packet when the first list includes the suppressed state identifier of the first user.

Optionally, the network server 101 is further configured to: record an occurrence time of a first fault of the first user, and accumulate a quantity of times of faults, where the quantity of times of faults is at least one of a quantity of times that the first user fails to get online on the network server or a quantity of times that the first user gets offline on the network server, and certainly, the quantity of times of faults may also be a sum of a quantity of times that the first user fails to get online on the network server and a quantity of times that the first user gets offline on the network server. The network server stores the suppressed state identifier of the first user in the first list when the quantity of times of faults of the first user within first duration is greater than or equal to a first threshold. The network server empties the quantity of times of faults of the first user after a time length, since the occurrence time of the first fault, of accumulating the quantity of times of faults by the network server reaches the first duration.

Optionally, the network server 101 is further configured to delete the suppressed state identifier of the first user from the first list after a time length for which the network server stores the suppressed state identifier of the first user in the first list reaches second duration.

Optionally, the network server 101 is further configured to send a second packet to the access device 102 when the first list includes the suppressed state identifier of the first user, where the second packet includes the suppressed state identifier of the first user.

The access device 102 is further configured to: receive the second packet sent by the network server 101, record the suppressed state identifier of the first user in the second list, and stop providing services to the first user.

Optionally, the access device 102 is further configured to discard the first packet when the second list includes the suppressed state identifier of the first user.

According to the virtual private network system provided in this embodiment of the present application, the user device sends a first packet to the access device. The access device searches an already stored second list for a suppressed state identifier of a first user according to an identifier of the first user after receiving the first packet sent by the user device, and sends the first packet to the network server when the second list does not include the suppressed state identifier of the first user. The network server searches an already stored first list for the state identifier of the first user according to the identifier of the first user, and discards the first packet if the state identifier is found. The network server and the access device jointly determine whether to suppress a user, so as to suppress unauthorized users efficiently and quickly, thereby resolving a problem in the prior art that a virtual private network system cannot effectively suppress unauthorized users.

An embodiment of the present application provides a network server on the basis of the embodiment corresponding to FIG. 1. Optionally, the network server may be an LNS. Referring to FIG. 2, the network server 20 includes a receiving unit 201, a searching unit 202, and a suppression unit 203.

The receiving unit 201 is configured to receive a first packet sent by an access device, where the first packet includes an identifier of a first user, and the identifier of the first user is used to identify the first user.

The searching unit 202 is configured to search an already stored first list for a suppressed state identifier of the first user according to the identifier of the first user received by the receiving unit 201.

The suppression unit 203 is configured to discard the first packet when the first list searched by the searching unit 202 includes the suppressed state identifier of the first user, where the suppressed state identifier of the first user is used to indicate not to provide services to the first user.

Optionally, the network server 203 is further configured to: record an occurrence time of a first fault of the first user, and accumulate a quantity of times of faults, where the quantity of times of faults is at least one of a quantity of times that the first user fails to get online on the network server or a quantity of times that the first user gets offline on the network server, and certainly, the quantity of times of faults may also be a sum of a quantity of times that the first user fails to get online on the network server and a quantity of times that the first user gets offline on the network server. The network server stores the suppressed state identifier of the first user in the first list when the quantity of times of faults of the first user within first duration is greater than or equal to a first threshold. The network server clears the quantity of times of faults of the first user after a time length, since the occurrence time of the first fault, of accumulating the quantity of times of faults by the network server reaches the first duration.

The suppression unit 203 is further configured to delete the suppressed state identifier of the first user from the first list after a time length for which the network server stores the suppressed state identifier of the first user in the first list reaches second duration.

Optionally, the network server 20 further includes a sending unit 204, configured to send a second packet to the access device when the first list includes the suppressed state identifier of the first user, where the second packet includes the suppressed state identifier of the first user, so that the access device stops providing services to the first user according to the suppressed state identifier of the first user.

The network server provided in this embodiment of the present application receives a first packet sent by an access device, searches an already stored first list for a state identifier of a first user according to an identifier of the first user, and discards the first packet if the state identifier is found. The network server participates in determining whether to suppress a user, so as to suppress unauthorized users efficiently and quickly, thereby resolving a problem in the prior art that a virtual private network system cannot effectively suppress unauthorized users.

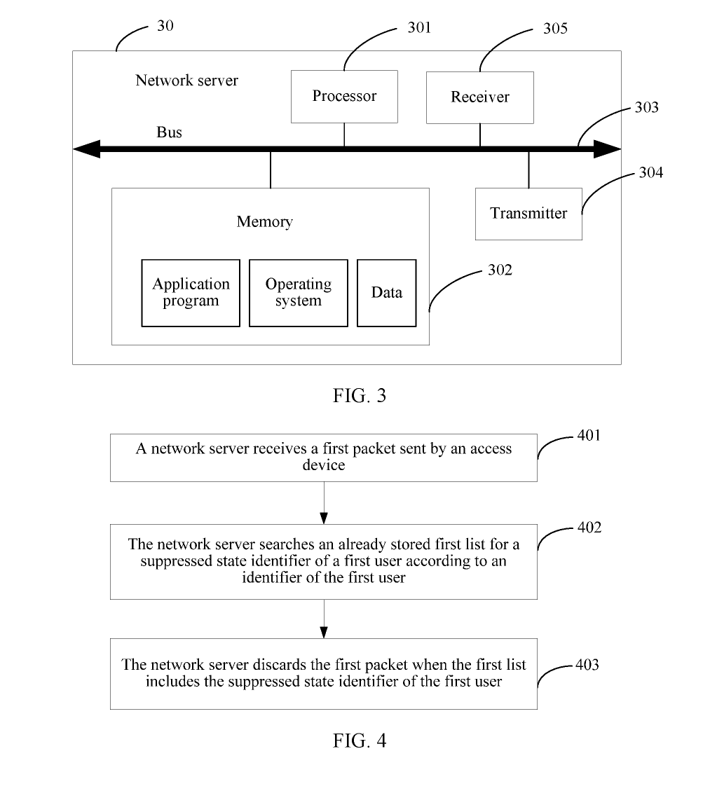

Another embodiment of the present application provides a network server 30 on the basis of the embodiment corresponding to FIG. 1. Referring to FIG. 3, the network server 30 includes: at least one processor 301, a memory 302, a bus 303, a transmitter 304, and a receiver 305. The at least one processor 301, the memory 302, the transmitter 304, and the receiver 305 are connected and complete communication with one another by using the bus 303.

The bus 303 may be an ISA (Industry Standard Architecture) bus, a PCI (peripheral component interconnect) bus, an EISA (Extended Industry Standard Architecture) bus, or the like. The bus 303 may be one or more of an address bus, a data bus, or a control bus. For ease of representation, the bus in FIG. 3 is represented by using only one bold line, but it does not indicate that there is only one bus or only one type of bus.

The memory 302 is configured to execute application program code of the solutions of the present application, and application program code for executing a solution of this embodiment of the present application is stored in the memory and is controlled and executed by the processor 301.

The memory may be a read-only memory ROM or a static storage device of another type that can store static information and an instruction; a random access memory RAM or a dynamic storage device of another type that can store information and an instruction; or an electrically erasable programmable read-only memory EEPROM, a compact disc read-only memory CD-ROM or other optical disk storage, optical disc storage (including a compact disc, a laser disc, an optical disc, a digital versatile disc, a Blu-ray disc, or the like), a disk storage medium or other disk storage, or any other medium that can be used to carry or store expected program code in a command or data structure form and that can be accessed by a computer, but is not limited thereto. These memories are connected to the processor by using the bus.

The processor 301 may be a central processing unit (Central Processing Unit, CPU for short), or an application specific integrated circuit (Application Specific Integrated Circuit, ASIC for short), or may be configured as one or more integrated circuits for implementing this embodiment of the present application.

The processor 301 is configured to call the program code in the memory 302, to execute operations of the searching unit and the suppression unit in the device embodiment corresponding to FIG. 2. For specific descriptions, refer to the device embodiment corresponding to FIG. 2, and details are not described herein again.

The network server provided in this embodiment of the present application receives a first packet sent by an access device, searches an already stored first list for a state identifier of a first user according to an identifier of the first user, and discards the first packet if the state identifier is found. The network server participates in determining whether to suppress a user, so as to suppress unauthorized users efficiently and quickly, thereby resolving a problem in the prior art that a virtual private network system cannot effectively suppress unauthorized users.

An embodiment of the present application provides a packet processing method on the basis of the embodiments corresponding to FIG. 1, FIG. 2, and FIG. 3. The method is applied to the network servers described in the embodiments corresponding to FIG. 1, FIG. 2, and FIG. 3. Referring to FIG. 4, the packet processing method provided in this embodiment includes:

401: A network server receives a first packet sent by an access device.

The first packet includes an identifier of a first user, where the identifier of the first user is used to identify the first user. Optionally, the identifier of the first user may be a calling number (Calling Number) of the first user. The first packet may be an online packet of the first user, including request information of the first user for accessing a virtual private network, or may be a data packet sent by the first user.

402: The network server searches an already stored first list for a suppressed state identifier of the first user according to an identifier of the first user.

The suppressed state identifier of the first user is used to indicate not to provide services to the first user.

Optionally, the network server records an occurrence time of a first fault of the first user, and accumulates a quantity of times of faults, where the quantity of times of faults is at least one of a quantity of times that the first user fails to get online on the network server or a quantity of times that the first user gets offline on the network server, and certainly the quantity of times of faults may also be a sum of a quantity of times that the first user fails to get online on the network server and a quantity of times that the first user gets offline on the network server; the network server stores the suppressed state identifier of the first user in the first list when the quantity of times of faults of the first user within first duration is greater than or equal to a first threshold; and clears the quantity of times of faults of the first user after a time length, since the occurrence time of the first fault, of accumulating the quantity of times of faults by the network server reaches the first duration.

The first threshold may be set according to a load condition of an access user on a network side, and a specific value of the first threshold is not limited in the present application.

Certainly, statistics are collected herein merely by using a failure in getting online or that a user gets offline as a fault, and other behaviors of a user may also be used as a fault for statistics collection, which is not limited in this embodiment.

403: The network server discards the first packet when the first list includes the suppressed state identifier of the first user.

Optionally, with reference to 402, if the first list includes the suppressed state identifier of the first user, it indicates that the quantity of times of faults of the first user has exceeded the first threshold, the first user is considered as an unauthorized user, and services are stopped being provided to the first user.

In addition, optionally, the network service deletes the suppressed state identifier of the first user from the first list after a time length for which the network server stores the suppressed state identifier of the first user in the first list reaches second duration.

According to the packet processing method provided in this embodiment of the present application, a network server receives a first packet sent by an access device, searches an already stored first list for a state identifier of a first user according to an identifier of the first user, and discards the first packet if the state identifier is found. The network server participates in determining whether to suppress a user, so as to suppress unauthorized users efficiently and quickly, thereby resolving a problem in the prior art that a virtual private network system cannot effectively suppress unauthorized users.

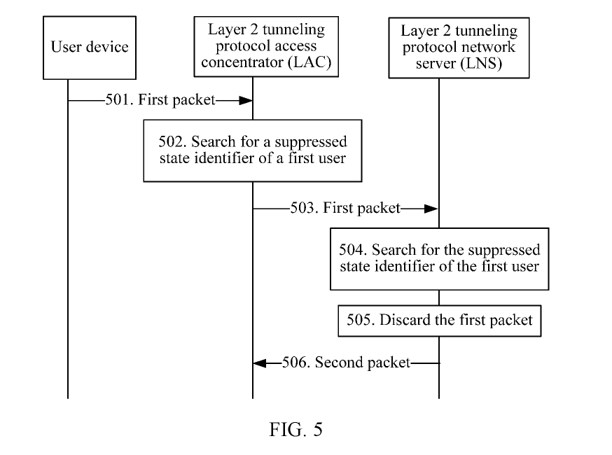

Another embodiment of the present application provides a packet processing method on the basis of the embodiment corresponding to FIG. 4. The method is applied to the virtual private network system described in the embodiment corresponding to FIG. 1. Optionally, this embodiment is described by using an example in which a network device is an LNS and an access device is an LAC. Certainly, this embodiment merely provides descriptions with an example, which does not represent that the present application is limited thereto. Referring to FIG. 5, the method includes:

501: A user device sends a first packet to an access device.

The first packet includes an identifier of a first user, where the identifier is used to identify the first user.

Optionally, the first packet may be an online packet of the first user or a data packet of the first user.

502: The access device searches an already stored second list for a suppressed state identifier of the first user according to an identifier of the first user.

The suppressed state identifier of the first user is used to indicate not to provide services to the first user.

Optionally, by searching for the suppressed state identifier of the first user in the second list, the LAC determines whether the first user is already locally suppressed, and if the second list includes the suppressed state identifier of the first user, the LAC may discard the first packet, and if the suppressed state identifier of the first user is not found, continue to execute 503.

503: The access device sends the first packet to a network server when the second list does not include the suppressed state identifier of the first user.

If the local LAC does not suppress the first user, the first packet may be sent to the LNS, and the LNS further determines whether the first user needs to be suppressed. In this way, the LNS on a network side also participates in determining whether to suppress the user, so that the network side in a virtual private network can suppress users efficiently and quickly.

504: The network server searches an already stored first list for the suppressed state identifier of the first user according to the identifier of the first user.

Optionally, the network server records an occurrence time of a first fault of the first user, and accumulates a quantity of times of faults, where the quantity of times of faults is at least one of a quantity of times that the first user fails to get online on the network server or a quantity of times that the first user gets offline on the network server, and certainly, the quantity of times of faults may also be a sum of a quantity of times that the first user fails to get online on the network server and a quantity of times that the first user gets offline on the network server; the network server stores the suppressed state identifier of the first user in the first list when the quantity of times of faults of the first user within first duration is greater than or equal to a first threshold; and clears the quantity of times of faults of the first user after a time length, since the occurrence time of the first fault, of accumulating the quantity of times of faults by the network server reaches the first duration.

With reference to 502, the access device may also record the quantity of times of faults of the user in the foregoing manner, and details are not described again in this embodiment.

505: The network server discards the first packet when the first list includes the suppressed state identifier of the first user.

Optionally, the network service deletes the suppressed state identifier of the first user from the first list after a time length for which the network server stores the suppressed state identifier of the first user in the first list reaches second duration.

506: Send a second packet to the access device.

The second packet includes the suppressed state identifier of the first user.

Optionally, the LNS receives the first packet, which proves that the local LAC does not suppress the first user, and the LNS informs the LAC to suppress the first user by sending the second packet including the suppressed state identifier of the first user to the LAC. If receiving a packet of the first user again, the LAC may directly discard the packet of the first user, thereby avoiding that excessive packet interaction between the LAC and the LNS occupies excessive resources.

According to the packet processing method provided in this embodiment of the present application, a user device sends a first packet to an access device. The access device searches an already stored second list for a suppressed state identifier of a first user according to an identifier of the first user after receiving the first packet sent by the user device, and sends the first packet to a network server when the second list does not include the suppressed state identifier of the first user. The network server searches an already stored first list for the state identifier of the first user according to the identifier of the first user, and discards the first packet if the state identifier is found. The network server and the access device jointly determine whether to suppress a user, so as to suppress unauthorized users efficiently and quickly, thereby resolving a problem in the prior art that a virtual private network system cannot effectively suppress unauthorized users.

With descriptions of the foregoing embodiments, a person skilled in the art may clearly understand that the present application may be implemented by hardware, firmware or a combination thereof. When the present application is implemented by software, the foregoing functions may be stored in a computer-readable medium or transmitted as one or more instructions or code in the computer-readable medium. The computer-readable medium includes a computer storage medium and a communications medium, where the communications medium includes any medium that enables a computer program to be transmitted from one place to another. The storage medium may be any available medium accessible to a computer. Examples of the computer-readable medium include but are not limited to: a RAM (Random Access Memory), a ROM (Read-Only Memory), an EEPROM (Electrically Erasable Programmable Read-Only Memory), a CD-ROM (Compact Disc Read-Only Memory) or other optical disc storage, a disk storage medium or other disk storage, or any other medium that can be used to carry or store expected program code in a command or data structure form and can be accessed by a computer. In addition, any connection may be appropriately defined as a computer-readable medium. For example, if software is transmitted from a website, a server or another remote source by using a coaxial cable, an optical fiber/cable, a twisted pair, a DSL (Digital Subscriber Line) or wireless technologies such as infrared ray, radio and microwave, the coaxial cable, optical fiber/cable, twisted pair, DSL or wireless technologies such as infrared ray, radio and microwave are included in fixation of a medium to which they belong. For example, a disk and a disc used by the present application includes a CD (Compact Disc), a laser disc, an optical disc, a DVD disc (Digital Versatile Disc), a floppy disk and a Blu-ray disc, where the disk generally copies data by a magnetic means, and the disc copies data optically by a laser means. The foregoing combination should also be included in the protection scope of the computer-readable medium.

The foregoing descriptions are merely specific implementation manners of the present application, but are not intended to limit the protection scope of the present application. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A virtual private network system, comprising:
a network server;
an access device; and
a user device, wherein
the user device is configured to send a first packet to the access device, wherein the first packet comprises an identifier of a first user, and the identifier of the first user is used to identify the first user;
the access device is configured to: receive the first packet sent by the user device, search an already stored second list for a suppressed state identifier of the first user according to the identifier of the first user, and send the first packet to the network server when the second list does not comprise the suppressed state identifier of the first user, wherein the suppressed state identifier of the first user is used to indicate not to provide services to the first user; and
the network server is configured to: receive the first packet sent by the access device, search an already stored first list for the suppressed state identifier of the first user according to the identifier of the first user, and discard the first packet when the first list comprises the suppressed state identifier of the first user.

2. The network system according to claim 1, wherein
the network server is further configured to: record an occurrence time of a first fault of the first user, and accumulate a quantity of times of faults, wherein the quantity of times of faults is at least one of a quantity of times that the first user fails to get online on the network server or a quantity of times that the first user gets offline on the network server, or the quantity of times of faults is a sum of a quantity of times that the first user fails to get online on the network server and a quantity of times that the first user gets offline on the network server; store the suppressed state identifier of the first user in the first list when the quantity of times of faults of the first user within first duration is greater than or equal to a first threshold; and clear the quantity of times of faults of the first user after a time length, since the occurrence time of the first fault, of accumulating the quantity of times of faults by the network server reaches the first duration.

3. The network system according to claim 1, wherein
the network server is further configured to delete the suppressed state identifier of the first user from the first list after a time length for which the network server stores the suppressed state identifier of the first user in the first list reaches second duration.

4. The network system according to claim 1, wherein
the network server is further configured to send a second packet to the access device when the first list comprises the suppressed state identifier of the first user, wherein the second packet comprises the suppressed state identifier of the first user; and
the access device is further configured to: receive the second packet sent by the network server, record the suppressed state identifier of the first user in the second list, and stop providing services to the first user.

5. The network system according to claim 1, wherein
the access device is further configured to discard the first packet when the second list comprises the suppressed state identifier of the first user.

6. A network server, applied to a virtual private network system, comprising:
a non-transitory computer readable storage medium to store program(s), and
computer hardware configured to implement, including configured by the program(s) to implement:
a receiving unit, configured to receive a first packet sent by an access device, wherein the first packet comprises an identifier of a first user, and the identifier of the first user is used to identify the first user;
a searching unit, configured to search an already stored first list for a suppressed state identifier of the first user according to the identifier of the first user received by the receiving unit; and
a suppression unit, configured to discard the first packet when the first list searched by the searching unit comprises the suppressed state identifier of the first user, wherein the suppressed state identifier of the first user is used to indicate not to provide services to the first user.

7. The network server according to claim 6, wherein
the suppression unit is further configured to: record an occurrence time of a first fault of the first user, and accumulate a quantity of times of faults, wherein the quantity of times of faults is at least one of a quantity of times that the first user fails to get online on the network server or a quantity of times that the first user gets offline on the network server, or the quantity of times of faults is a sum of a quantity of times that the first user fails to get online on the network server and a quantity of times that the first user gets offline on the network server; store the suppressed state identifier of the first user in the first list when the quantity of times of faults of the first user within first duration is greater than or equal to a first threshold; and clear the quantity of times of faults of the first user after a time length, since the occurrence time of the first fault, of accumulating the quantity of times of faults by the network server reaches the first duration.

8. The network server according to claim 6, wherein
the suppression unit is further configured to delete the suppressed state identifier of the first user from the first list after a time length for which the network server stores the suppressed state identifier of the first user in the first list reaches second duration.

9. The network server according to claim 6, wherein
the computer hardware is further configured to implement a sending unit, configured to send a second packet to the access device when the first list comprises the suppressed state identifier of the first user, wherein the second packet comprises the suppressed state identifier of the first user, so that the access device stops providing services to the first user according to the suppressed state identifier of the first user.

10. A packet processing method, applied to a virtual private network system, comprising:
receiving, by a network server, a first packet sent by an access device, wherein the first packet comprises an identifier of a first user, and the identifier of the first user is used to identify the first user;
searching, by the network server, an already stored first list for a suppressed state identifier of the first user according to the identifier of the first user; and
discarding, by the network server, the first packet when the first list comprises the suppressed state identifier of the first user, wherein the suppressed state identifier of the first user is used to indicate not to provide services to the first user.

11. The method according to claim 10, wherein the method further comprises:
recording, by the network server, an occurrence time of a first fault of the first user, and accumulating a quantity of times of faults, wherein the quantity of times of faults is at least one of a quantity of times that the first user fails to get online on the network server or a quantity of times that the first user gets offline on the network server, or the quantity of times of faults is a sum of a quantity of times that the first user fails to get online on the network server and a quantity of times that the first user gets offline on the network server;
storing, by the network server, the suppressed state identifier of the first user in the first list when the quantity of times of faults of the first user within first duration is greater than or equal to a first threshold; and
clearing the quantity of times of faults of the first user after a time length, since the occurrence time of the first fault, of accumulating the quantity of times of faults by the network server reaches the first duration.

12. The method according to claim 10, wherein the method further comprises:
deleting, by the network server, the suppressed state identifier of the first user from the first list after a time length for which the network server stores the suppressed state identifier of the first user in the first list reaches second duration.

13. The method according to claim 10, wherein the method further comprises:
sending, by the network server, a second packet to the access device when the first list comprises the suppressed state identifier of the first user, wherein the second packet comprises the suppressed state identifier of the first user, so that the access device stops providing services to the first user according to the suppressed state identifier of the first user.
